(19) United States
(12) Patent Application Publication
(10) Pub. No.: US 2009/0071077 A1
(43) Pub. Date: Mar. 19, 2009

(54) Automotive glass run

(75) Inventors: Tomohiro Takase, Aichi-ken (JP); Masanori Aritake, Aichi-ken (JP); Satoshi Toki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Toyoda Gosei Co., Ltd., Nishikasugai-gun (JP)

(21) Appl. No.: 12/230,514

(22) Filed: Aug. 29, 2008

(30) Foreign Application Priority Data
Aug. 31, 2007 (JP) P2007-225986

(51) Int. Cl. E06B 7/16

(52) U.S. Cl. 49/489.1

(57) ABSTRACT

A main body of automotive glass run assumes a substantially U-shaped cross section consisting of a vehicle-exterior side wall, an interior side wall, and a bottom wall and is provided with a vehicle-exterior seal lip and an interior seal lip. The bottom wall is made of a solid material or a microfoaming solid material, and the vehicle-exterior side wall and the interior side wall are made from a sponge material. A vehicle-exterior projection, which assumes a triangular cross-sectional profile and whose top inwardly protrudes so as to be able to contact a door glass, is formed on an interior surface of the vehicle-exterior side wall. A low sliding resistance material layer is formed on a surface of the vehicle-exterior projection.

### BACKGROUND OF THE INVENTION

1. Field of the Invention

The present invention relates to a glass run that is attached to inner peripheral parts of longitudinal sides of a door frame of an automotive door and that guides ascending and descending operations of door glass.

2. Related Art

As shown in FIG. 3, glass run 110 for guiding ascending and descending operations of door glass 5 is attached to an inner peripheral part of a door frame 2 of an automotive door 1. The entirety of the related-art glass run 110 is shown in FIG. 2, and a cross-sectional view of the related-art glass run 110 attached to linear portions of the door frame 2 is shown in FIGS. 4 and 5.

Conventionally, the glass run 110 is attached to the inside of a channel of the door frame 2 as shown in FIG. 3, to guide the ascending and descending operations of the door glass 5 and seal a space between the door glass 5 and the door frame 2. Further, as shown in FIG. 2, the glass run 110 connects an upper side portion of the door frame 2, which is formed with linear portions 111 formed by extrusion molding, to front longitudinal sides and rear longitudinal sides, which are similarly formed by extrusion molding, by corners 112 die-molded in conformance with the shape of corners 2b of the door frame 2.

A seal between the door 1 and a vehicle body is formed with a door weather strip (not shown) attached to an outer perimeter of a door panel and the outer perimeter of the door frame 2 and/or an opening trim weather strip (not shown) attached to flanges of openings of the vehicle body.

As shown in FIG. 4, the linear portions 111 of the main body of the glass run 110 constitute a substantially U-shaped cross section consisting of a vehicle-exterior side wall 120, a vehicle-interior side wall 130, and a bottom wall 140. An external vehicle wind lip 121 is provided so as to extend from the vicinity of the leading edge of the vehicle-exterior side wall 120 toward an inside of the substantially U-shaped area of the main body. Moreover, an internal vehicle seal lip 131 is provided even on the vehicle-interior side wall 130 so as to extend from the vicinity of a leading edge of the vehicle-interior side wall 130 toward the inside of the substantially U-shaped cross section.

The vehicle-exterior side wall 120, the vehicle-interior side wall 130, and the bottom wall 140 of the main body of the glass run 110 are inserted into to a channel 103 formed in the door frame 2, and at least portions of vehicle-exterior surfaces of the walls are brought into press contact with a vehicle-interior surface of the channel 103, to hold the glass run 110. As shown in FIG. 4, there are cases where the channel 103 is made by bending the door frame 2 or where the channel 103 is made by fitting a channel formed with a separate member.

A vehicle-exterior cover lip 122 is provided essentially parallel to, in an extending manner, the outside of the vehicle-exterior side wall 120, and a vehicle-interior cover lip 132 is provided essentially parallel to, in an extending manner, the outside of the vehicle-interior sidewall 130. Thus, side edges of the channel 103 are sandwiched between the vehicle-exterior and vehicle-interior side walls, to hold the glass run 110.

The door glass 5 performs slidable movement over the inside of the main body of the glass run 110 having a substantially U-shaped cross section, and side surfaces of an edge of the door glass 5 are sealed and held by the vehicle-exterior wind lip 121 and the vehicle-interior seal lip 131.

The vehicle-exterior side wall 120, the vehicle-interior side wall 130, and the bottom wall 140 of the main body of the glass run 110 are formed with an ordinary solid material, such as rubber or a synthetic resin and exhibit large specific gravity, so that the overall weight of the glass run 110 becomes great, which defies a recent request for a reduction in the weight of the vehicle.

For this reason, in some glass run 110, the vehicle-exterior side wall 120, the vehicle-interior side wall 130, and the bottom wall 140 of the main body are formed with a microfoaming solid material as shown in FIG. 4 (see; for instance, JP-A-6-183305).

However, it has been impossible to attempt to achieve a sufficient weight reduction by the microfoaming solid material. In order to move the door glass 5 outside of the vehicle, to reduce a step between the door glass 5 and the door frame 2, the vehicle-exterior side wall 120 is reduced. When the vehicle-exterior sidewall 120 is formed with a sponge material, it may arise the case where the vehicle-exterior side wall may become flat or anomalously deformed when the door glass 5 ascends or descends because of the smallness of the vehicle-exterior side wall 120, low rigidity of the sponge material, and secular changes.

As shown in FIG. 5, when the door glass 5 ascends or descends within the main body of a glass run 210, vibrations arise in the door glass 5 for reasons of vibrations of a vehicle, or the like. At this time, a peeling sound occurs between the vehicle-exterior side wall 220 and the vehicle-exterior wind lip 221 or between the vehicle-interior side wall 230 and the vehicle-interior seal lip 231. In order to prevent generation of such a peeling sound, a technique for generating an elastic member between them has been disclosed (see; for instance, JP-A-2002-130482).

However, when the vehicle-exterior side wall 220 and the vehicle-interior sidewall 230 are formed with a sponge material for reducing the weight of the glass run 210, there arises a problem of the glass run becoming flat when the door glass 5 ascends or descends as mentioned above.

### SUMMARY OF THE INVENTION

Accordingly, the present invention aims at providing a glass run that yields a large weight-reduction effect; that exhibits sufficient strength even at the time of ascending or descending operation of a door glass; and that can prevent generation of a sliding sound, which would otherwise be caused by secular changes.

In order to solve the problem, the first aspect of the present invention provides an automotive glass run attached to an inner peripheral part of a longitudinal side of a door frame of an automotive door and that guides ascending and descending a door glass, comprising:

a main body having a substantially U-shaped cross section formed with a vehicle-exterior side wall, a vehicle-interior side wall and a bottom wall,

wherein a vehicle-exterior wind lip is extended from a leading edge of the vehicle-exterior side wall in a direction that is slant toward outside of the main body for contacting the door glass, and

a vehicle-interior seal lip is extended from the vehicle-interior side wall toward an inside of the main body;

wherein the bottom wall is made of a solid material or a microfoaming solid material, and the vehicle-exterior side wall and the vehicle-interior side wall are made from a sponge material;

where in a vehicle-exterior projection having a triangular cross section, a top of which protrudes inwardly so as to be contact the door glass is formed on a vehicle-interior surface of the vehicle-exterior side wall, and

a low sliding resistance material layer is formed on a surface of the vehicle-exterior projection; and

wherein the vehicle-exterior projection seals a vehicle-exterior side surface of an edge of the door glass, and the vehicle-interior seal lip seals a vehicle-interior side surface of the edge of the door glass.

In the present invention, a main body of the glass run in a linear portion has a substantially U-shaped cross section consisting of a vehicle-exterior side wall, a vehicle-interior side wall, and a bottom wall; and is provided with a vehicle-exterior wind lip extending from a leading edge of the vehicle-exterior side wall in a direction which slants outside of the main body of the glass run and in which glass run contacts the door glass. Further, the vehicle-interior side wall is provided with a vehicle-interior seal lip which extends toward an inside of the main body having the substantially U-shaped cross section.

Consequently, when the door is closed, the leading edge of the door glass can be housed, at an upper side and a longitudinal side of the door frame, in the glass run having a main body of a substantially U-shaped cross section consisting of the vehicle-exterior side wall, the vehicle-interior side wall, and the bottom wall and that assumes, so that the door glass can be securely held. Further, both the vehicle-exterior wind lip and the vehicle-interior seal lip contact the door glass, at the longitudinal sides of the linear portions, along with ascending or descending operation of the door glass, whereby the door glass can be held by the vehicle-exterior wind lip and the vehicle-interior seal lip.

The bottom wall is made of a solid material or a microfoaming solid material, and the vehicle-exterior sidewall and the vehicle-interior side wall are made from a sponge material. Therefore, the bottom wall exhibits high rigidity. When the door glass ascends, to enter the main body of the glass run, anomalous deformation of the bottom wall, which would otherwise be caused by the leading edge of the door glass, does not arise, so that the vehicle-exterior side wall and the vehicle-interior side wall can be securely held.

The vehicle-exterior side wall and the vehicle-interior side wall accounting for large proportions of the entire volume of the glass run can be produced from a sponge material having small specific gravity, so that the overall weight of the glass run can be greatly reduced, to contribute to weight reduction of a vehicle.

A vehicle-exterior projection, which assumes a triangular cross-sectional profile and whose top projects inwardly so as to be able to contact door glass, is formed on a vehicle-interior surface of the vehicle-exterior side wall. On this account, the triangular vehicle-exterior projection enables enhancement of the rigidity of the vehicle-exterior side wall. Therefore, even when the vehicle-exterior side wall is formed with a sponge material, anomalous deformation of the vehicle-exterior side wall, which would otherwise be caused by the leading edge of the door glass when the door glass enters the main body of the glass run, does not arise, the door glass can be securely held, and a sealing characteristic can be maintained. Further, the glass run does not protrude from the door frame, so that superior appearance is offered.

Further, since the low sliding resistance material layer is formed on the surface of the vehicle-exterior projection, the door glass can readily perform sliding movement when the door glass enters the main body of the glass run while the vehicle-exterior projection contacts and holds the side surfaces of the door glass, so that generation of an unusual sound and occurrence of vibrations in the door glass can be prevented.

The vehicle-exterior side surface of the edge of the door glass is sealed with the vehicle-exterior projection, and the vehicle-interior side surface of the operation of the door glass is sealed with the vehicle-interior seal lip. Therefore, the vehicle-exterior side surface of the operation of the door glass is sealed with the vehicle-exterior projection, to enhance the sealing characteristic and prevent generation of a sliding sound because the door glass is held by the vehicle-exterior projection. The vehicle-interior side surface of the door glass can be sealed with the vehicle-interior seal lip.

The second aspect of the invention is directed to automotive glass run, wherein one operation of a bottom side of the triangular cross section of the vehicle-exterior projection is located in a vicinity of a joint between the projection and the bottom of the vehicle-exterior side wall, and the other operation of the bottom side is located in a vicinity of a leading edge of the vehicle-exterior side wall.

In the invention, one operation of a bottom side of the triangular cross section of the vehicle-exterior projection is located in a vicinity of a joint between the projection and the bottom of the vehicle-exterior side wall, and the other operation of the bottom side is located in a vicinity of a leading edge of the vehicle-exterior side wall. Therefore, the essentially-entire length of the vehicle-exterior side wall can be held by the bottom side of the triangular cross-sectional profile of the vehicle-exterior projection, and deformation of the vehicle-exterior side wall can be thoroughly prevented.

The third aspect of the invention is directed toward automotive glass run, wherein the low sliding resistance material layer on the surface of the vehicle-exterior projection is an olefin-based resin sheet.

In the third aspect of the invention, the low sliding resistance material layer on the surface of the vehicle-exterior projection is an olefin-based resin sheet, and hence low abrasion and low sliding resistance are achieved. Further, when the vehicle-exterior side wall is formed with EPDM or an olefin-based thermoplastic elastomer, the vehicle-exterior side wall can be strongly welded or bonded to the vehicle-exterior projection.

A fourth aspect of the invention is directed toward automotive glass run, wherein an ultrahigh molecular polyethylene layer as the low sliding resistance material layer is formed on the surface of the bottom wall.

In the fourth aspect of the invention an ultrahigh molecular polyethylene layer of the low sliding resistance material is formed on the surface of the bottom wall. Hence, even when one operation of the door glass performs sliding movement upon contact with the surface of the bottom wall, the door glass can smoothly ascend or descend, so that a sliding sound resultant from ascending or descending operation is small.

A fifth aspect of the invention is directed toward automotive glass run, wherein the low sliding resistance material layer is formed on a vehicle-interior surface of the vehicle-exterior wind lip and a surface of the vehicle-interior seal lip.

In the invention of the fifth aspect of the invention, the low sliding resistance material layer is formed on a vehicle-interior surface of the vehicle-exterior wind lip and a surface of the vehicle-interior seal lip. Even when the door glass enters the main body of the glass run, to make sliding operation, sliding resistance between the vehicle-exterior wind lip and the vehicle-interior seal lip can be lessened, so that smooth ascending and descending operation of the door glass can be maintained.

A sixth aspect of the invention is characterized in that the vehicle-interior side wall and the vehicle-interior seal lip are formed so as to become larger and thicker than the vehicle-exterior side wall and the vehicle-exterior wind lip, respectively.

In the sixth aspect of the invention, the vehicle-interior side wall and the vehicle-interior seal lip of the glass run are formed so as to become larger and thicker than the vehicle-exterior side wall and the vehicle-exterior wind lip, respectively. Hence, the door glass can be securely held, and the door glass can be positioned in a direction outside of the vehicle. A step between the door glass and the door frame can be reduced, and a reduction in wind sound and superior appearance can be achieved. Further, the area of a vehicle-exterior-side area of the door frame or door molding can be reduced, so that preferable design is offered.

A second aspect of the invention is directed toward automotive glass run, wherein specific gravity of the sponge material ranges from 0.3 to 0.8.

In the second aspect of the invention, the interior side wall and the vehicle-exterior sidewall, which account for large proportions of the entire volume of glass run, are formed with a sponge material whose specific gravity ranges from 0.3 to 0.8. Hence, small specific gravity and a great reduction in the overall weight of glass run can be attained.

An eighth aspect of the invention is directed toward automotive glass run, wherein specific gravity of the solid material or the microfoaming solid material ranges from 0.8 to 1.2.

In the eighth aspect of the invention, the bottom wall, or the like, is formed with a solid material or a microfoaming solid material whose specific gravity ranges 0.8 to 1.2. Hence, the solid material does not involve an increase in weight, and rigidity can be maintained.

A ninth aspect of the invention is directed toward automotive glass run, wherein a recess is formed in a vehicle-exterior surface of the vehicle-exterior side wall, and an operation of the door frame or an operation of a door molding is fitted into the recess, thereby holding the vehicle-exterior side wall.

In the ninth aspect of the invention, a recess is formed in a vehicle-exterior surface of the vehicle-exterior sidewall, and an edge of the door frame or an edge of a door molding is fitted into the recess, thereby holding the vehicle-exterior side wall. Therefore, the vehicle-exterior side wall is securely held by the door frame or the door molding, whereby the space between the vehicle-exterior side wall and the door glass is thoroughly sealed without involvement of removal of the vehicle-exterior side wall even when the door glass ascends or descends, and the external appearance of the vehicle can be enhanced.

In the present invention, the bottom wall is made of a solid material or a microfoaming solid material, and the vehicle-exterior side wall and the interior side wall are made from a sponge material. Therefore, the bottom wall exhibits high rigidity, and anomalous deformation of the bottom wall, which would otherwise be caused by the leading edge of the door glass, does not arise, so that the vehicle-exterior side wall and the interior side wall can be securely held.

The vehicle-exterior side wall and the interior side wall can be produced from a sponge material having small specific gravity, so that the overall weight of the glass run can be greatly reduced, to contribute to weight reduction of a vehicle.

A vehicle-exterior projection, which assumes a triangular cross-sectional profile and whose top projects inwardly so as to be able to contact door glass, is formed on an interior surface of the vehicle-exterior side wall. On this account, the triangular vehicle-exterior projection enables enhancement of the rigidity of the vehicle-exterior side wall. Even when the vehicle-exterior side wall is formed with a sponge material, anomalous deformation of the vehicle-exterior side wall does not arise. Since the low sliding resistance material layer is formed on the surface of the vehicle-exterior projection, the door glass can readily perform sliding movement. Thus, generation of an unusual sound and occurrence of vibrations in the door glass can be prevented.

### BRIEF DESCRIPTION OF THE DRAWINGS

FIG. 1 is a cross-sectional view of glass run, which is an embodiment of the present invention and in a state of being attached to an upper side, taken along line A-A shown in FIG. 3;

FIG. 2 is a front view of the glass run that is the embodiment of the present invention;

FIG. 3 is a front view of an automotive door;

FIG. 4 is a cross-sectional view of the related-art glass run attached to an upper side; and

FIG. 5 is a perspective view of another related-art glass run attached to an upper side.

### DETAILED DESCRIPTION OF THE PREFERRED EMBODIMENTS

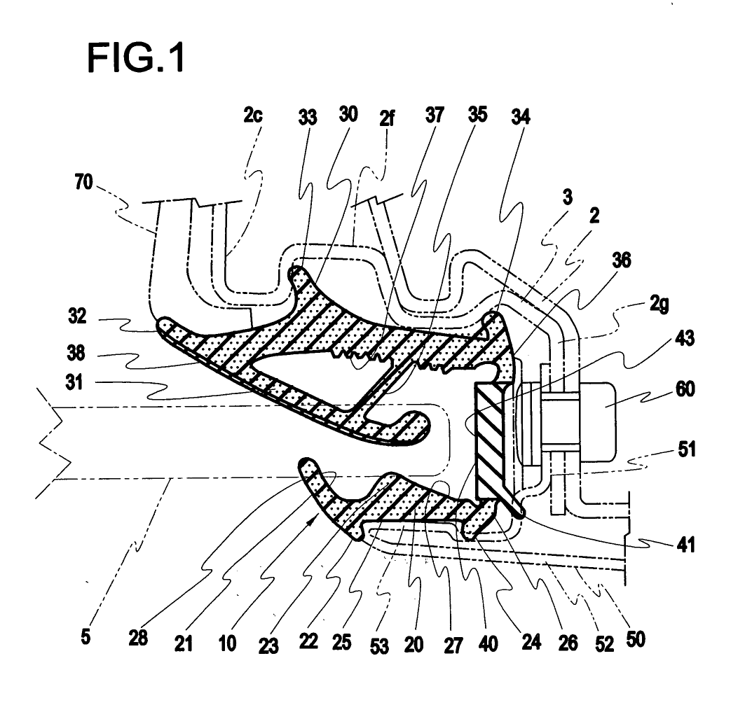

An embodiment of the present invention will be described by reference to FIGS. 1 through 3.

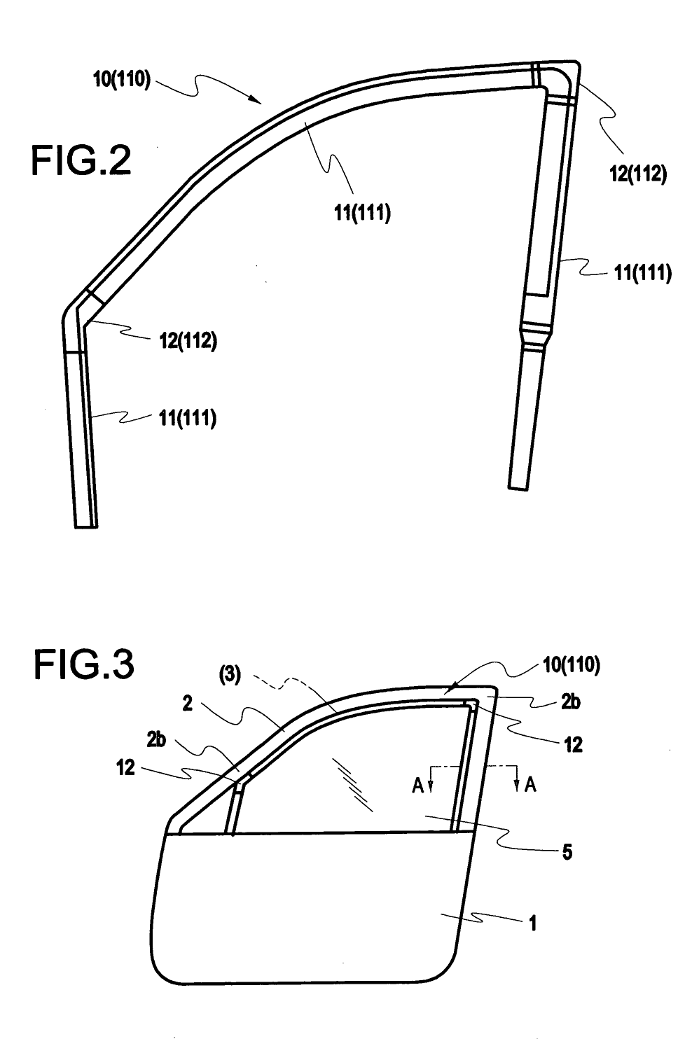

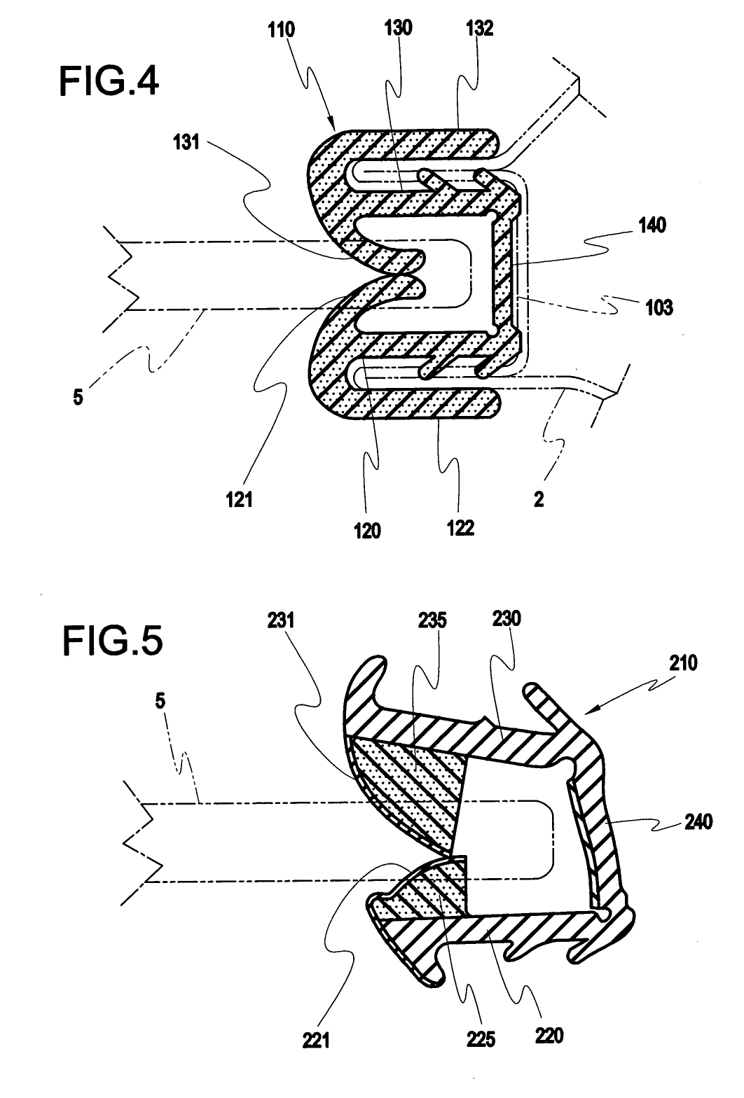

FIG. 3 is a front view of a front door 1 of an automobile, and FIG. 2 is a front view of glass run 10 of the front door to be attached to a door frame 2 of the door 1. As shown in FIG. 3, the door frame 2 is attached to an upper portion of the door 1, and door glass 5 is attached to the door frame so as to be able to freely ascend or descend. Specifically, the glass run 10 is attached to an inner peripheral part of the door frame 2, thereby guiding ascending and descending operations of the door glass 5 and sealing a gap between the door glass 5 and the door frame 2.

As shown in FIG. 2, the glass run 10 includes linear portions 11 wholly formed by extrusion molding and corners 12 that are to be attached to corners 2b of the door frame 2, to interconnect the linear portions 11, and that are formed by die molding.

Each of the linear portions 11 includes an area that is to be attached to the upper side of the door frame 2; an area that is to be attached to a rear longitudinal side of the door frame 2; and an area that is to be attached to a division sash constituting a front longitudinal side of the door frame 2.

The corners 12 are die-molded and connected to the linear portions 11 at respective front and rear corners in such a way that the extrusion-molded portions assume a shape conforming to the door frame 2. The corners 12 of the glass run 10 are attached to the corners 2b of the door frame 2.

The following descriptions are provided by taking, by way of example, the glass run 10 attached to the longitudinal side of the front door 1.

FIG. 1 is a cross-sectional view of the glass run 10 attached to the longitudinal side of the door frame 2 taken along line A-A shown in FIG. 3.

In relation to a cross-sectional profile of each of the linear portions 11 of the glass run 10 attached to the longitudinal sides of the door frame 2, the main body of the linear portion is formed into a substantially U-shaped cross section made up of a vehicle-exterior side wall 20, an interior side wall 30, and a bottom wall 40, as shown in FIG. 1. As will be described later, the interior side wall 30 is formed so as to become larger and thicker than the vehicle-exterior sidewall 20, and an interior part of the substantially U-shaped cross section is formed into a large asymmetrical shape.

In the main body of the glass run 10, a portion of the main body attached to the longitudinal side of the door frame 2 and a portion of the same attached to the upper side of the door frame basically assume an essentially-similar C-shaped cross-sectional profile.

The glass run 10 of the present invention is attached to the longitudinal side of the door frame 2, and a door molding 50 is attached to an outer peripheral surface of a leading edge of the door frame 2. The leading edge of the door frame 2 is bent to form a channel 3 having an essentially-L-shaped cross section. The glass run 10 is held by the channel 3 and the door molding 50.

In the door molding 50, a door molding mount section 51 serving as one edge is attached to a horizontal surface located close to the leading edge of the door frame 2 by a mount screw 60, or the like, thereby forming a door molding hold section 53 bent from the door molding mount section 51 into an essentially-quadrature shape. The door molding hold section 53 is fitted into a vehicle-exterior hold recess 25 to be described later, thereby holding the vehicle-exterior side wall 20.

A door molding decoration 52 bent from the door molding hold section 53 into the shape of a hairpin covers the leading edge of the door frame 2, to form a decoration in the outer perimeter of the door frame 2.

The glass run 10 can also be held without use of the door molding 50 by bending the door frame 2 to form the channel 3 having an essentially-U-shaped cross section.

The portion having a substantially U-shaped cross-section is formed with the door molding 50 and a leading edge of an outer panel 2c of the door frame 2, and the glass run 10 is held in that portion.

Further, the vehicle-exterior side wall 20 is formed so as to become smaller than the interior sidewall 30 to be described later, so that the area of a portion of the door molding 7 located outside the vehicle can be reduced, to offer design preference.

The vehicle-exterior side wall 20 of the glass run 10 is formed with a sponge material.

The vehicle-exterior wind lip 21 is formed so as to extend from the vicinity of a leading edge of the vehicle-exterior side wall 20 to a direction in which the lip contacts the door glass 5 in an obliquely upward direction from the leading edge of the vehicle-exterior sidewall 20; namely, toward the interior seal lip 31. The vehicle-exterior cover lip 22 is formed so as to extend to the outside of the vehicle from the leading edge of the vehicle-exterior sidewall 20. The vehicle-exterior cover lip 22 covers a bent leading edge of the door molding 50.

A vehicle-exterior projection 23, which assumes a triangular cross-sectional profile and which projects in an internally-lateral direction in such a way that a top of the triangle can contact the door glass 5, is formed on an interior surface of the vehicle-exterior side wall 20. The triangular vehicle-exterior projection 23 enables an increase in the thickness and rigidity of the vehicle-exterior side wall 20. Therefore, even when formed with a sponge material, the vehicle-exterior side wall 20 still remains bulky and exhibits rigidity by virtue of formation of the vehicle-exterior projection 23. Even when underwent compression induced by advancement of the door glass 5, the vehicle-exterior side wall is less subjected to flattening, and an anomalous increase in the contact area between the vehicle-exterior side wall and the door glass 5 does not occur. Further, a sealing characteristic existing between the door glass 5 and the glass run 10 can be assured. The vehicle-exterior side wall 20 and the vehicle-exterior wind lip 21 do not project from the door frame 2, to produce superior appearance.

Since the vehicle-exterior projection 23 assumes a triangular shape rather than a lip shape, the projection is not involved in ascending and descending operations of the door glass 5, thereby securely holding the door glass 5. Moreover, a low sliding resistance material layer 27 is formed on the surface of the vehicle-exterior projection 23, and hence, upon entering the main body of the glass run 10, the door glass 5 can readily perform sliding operation while the vehicle-exterior projection 23 holds the side surface of the door glass 5. Combined with the foregoing operation, the glass run can prevent generation of a sliding sound. Further, occurrence of vibrations in the door glass 5 can be prevented by holding the door glass with the vehicle-exterior projection 23.

A vehicle-exterior hold lip 24 is formed on a part of the vehicle-exterior surface of the vehicle-exterior side wall 20 close to the bottom wall 40. A vehicle-exterior hold recess 25 is formed between the vehicle-exterior hold lip 24 and the vehicle-exterior cover lip 22. As mentioned above, the door molding hold section 53 of the door molding 50 is fitted into the vehicle-exterior hold recess 25, thereby holding the vehicle-exterior side wall 20.

Thereby, the vehicle-exterior side wall 20 formed with a sponge material can be securely held by the door molding 50. Therefore, even when the door glass 5 ascends or descends, disconnection of the vehicle-exterior side wall 20 from the door molding 50, which would be caused when the side wall is dragged by the door glass 5, does not arise, and secure seal is realized. Further, the door glass 5 does not project to the outside of the vehicle, so that vehicle-exterior appearance of the vehicle can be enhanced.

Although formed with a sponge material, the vehicle-exterior side wall 20 accounts for a large proportion of the overall volume of the glass run 10 together with the interior side wall 30 to be described later, as shown in FIG. 1. Such a large proportion can be formed with a sponge material having low specific gravity, and the overall weight of the glass run 10 can be greatly reduced, to contribute to weight reduction of the vehicle.

The specific gravity of the sponge material preferably ranges from 0.3 to 0.8. When the vehicle-exterior side wall 20 is formed with a sponge material whose specific gravity ranges from 0.3 to 0.8, the overall weight of the glass run 10 can be greatly reduced while the shape of the glass run is maintained.

The vehicle-exterior side wall 20 is linked to the bottom wall 40 by a vehicle-exterior joint 26. A groove is formed in an interior surface of the vehicle-exterior joint 26. Even when the vehicle-exterior side wall 20 and the interior side wall 30 become wide open in the form of slanting eyebrows with respect to the bottom wall 40 during manufacture, the area between the vehicle-exterior side wall 20 and the bottom wall 40 becomes easy to deflect when the channel 3 is attached to the glass run 10, thereby facilitating attachment operation.

The vehicle-exterior wind lip 21 is extended from the leading edge of the vehicle-exterior sidewall 20 in a direction where the lip contacts the door glass 5 as well as in an oblique external direction with respect to the main body of the glass run 10. Both side surfaces of the leading edge of the door glass 5 are held by the vehicle-exterior wind lip 21, the vehicle-exterior projection 23, and the interior seal lip 31. Along with ascending or descending operation of the door glass 5, the vehicle-exterior wind lip 21, the vehicle-exterior projection 23, and the interior seal lip 31 to be described later contact side surfaces of the door glass 5, thereby sealing the space between the door frame 2 and the door glass 5.

The vehicle-exterior wind lip 21 is preferably formed with a sponge material as is the vehicle-exterior side wall 20. In this case, high flexibility is attained. When the door glass 5 ascends, to enter the main body of the glass run 10, the wind lip reliably contacts the door glass in accordance with movement of the door glass 5, so that a sealing characteristic can be assured.

The low sliding resistance material layer 28 can be formed on the interior surface of the vehicle-exterior wind lip 21. In this case, even when the door glass 5 enters the main body of the glass run 10 and performs slidable movement, sliding resistance arising among the vehicle-exterior wind lip 21, the interior seal lip 31, and the door glass 5 can be lessened, and smooth ascending and descending operations of the door glass 5 can be maintained.

The low sliding resistance material layer 27 of the vehicle-exterior projection 23 and the low sliding resistance material layer 28 of the vehicle-exterior wind lip 21 can be produced by simultaneous extrusion of a material, which contain a large proportion of olefin in thermoplastic elastomer and which exhibit low sliding resistance, to a thickness of the order of 0.1 mm over the surface of the vehicle-exterior wind lip 21 and the interior seal lip 31; by application of a silicon resin or an urethane resin; or by affixation of a polymeric polyethylene sheet, and the like.

Provided that the low sliding resistance material layer 28 is produced on the interior surface of the vehicle-exterior wind lip 21, close contacting of the vehicle-exterior wind lip 21 with the door glass 5, which would otherwise arise when the door glass 5 enters the main body of the glass run 10, can be prevented, whereupon a sliding characteristic can be assured. Moreover, a convex ridge can also be produced in place of the low sliding resistance material layer 28 on the interior surface of the vehicle-exterior wind lip 21. Further, a low sliding resistance material layer may also be produced on a vehicle-exterior surface of the vehicle-exterior wind lip 21, as well.

The interior side wall 30 will now be described.

The interior side wall 30 is produced so as to become thicker and greater than the vehicle-exterior side wall 20. Therefore, the glass run 10 can be firmly held on the door frame 2.

Moreover, since the interior side wall 30 is produced so as to become thicker and greater than the vehicle-exterior side wall 20, the door glass 5 can be oriented in the outside direction of the vehicle within the main body of the glass run 10. A step between the door glass 5 and the door molding 50 can be reduced, so that a wind sound can be lessened and superior appearance can be provided.

The interior side wall 30 is formed with a sponge material as is the vehicle-exterior side wall 20. The interior side wall 30 is large as shown in FIG. 1 and accounts for a large proportion of the entire volume of the glass run 10. Such a large proportion of the glass run can be produced from a sponge material having small specific gravity, so that the overall weight of the glass run 10 can be greatly reduced, to contribute to weight reduction of a vehicle.

As in the case of the vehicle-exterior side wall 20, the specific gravity of the sponge material preferably ranges from 0.3 to 0.8. When the interior side wall 30 is produced from a sponge material whose specific gravity ranges from 0.3 to 0.8, the overall weight of the glass run 10 can be greatly reduced.

The interior projection 33 is formed on a leading-edge side of a vehicle-exterior surface of the vehicle-exterior side wall 30, and an interior hold lip 34 is formed in the vicinity of an area continuous to the bottom wall 40. Recesses 2f, 2g are formed by bending two locations on the outer panel 2c of the door frame 2, and the interior projection 33 and the interior hold lip 34 are engaged with the recesses 2f, 2g. Therefore, the glass run 10 is held on the door frame 2 by the foregoing door molding 7 and the recesses 2f, 2g, thereby sealing the space between the interior side wall 30 and the outer panel 2c.

The interior side wall 30 is joined to the bottom wall 40 by an interior joint 36. A groove is formed in an interior surface of the interior joint 36. When the channel 3 is attached to the glass run 10, the area between the interior side wall 30 and the bottom wall 40 becomes easy to deflect, thereby facilitating attachment operation, as in the case of the vehicle-exterior joint 26.

A plurality of interior ridges 37 are continually formed on the interior surface of the interior side wall 30 in a longitudinal direction. Even when the leading edge of the interior seal lip 31, which will be described later, is brought into press contact with the interior surface of the interior side wall 30 as a result of the door glass 5 entering the main body of the glass run 10, close contact of the interior seal lip 31 with the interior surface of the interior side wall 30 can be prevented, to prevent generation of an unusual sound.

Moreover, an interior bridge 35 for linking the interior side wall 30 to the interior seal lip 31 may also be provided. In this case, even when the door glass 5 enters the main body of the glass run 10, the interior seal lip 31 can be pressed against the side surface of the door glass 5, whereby the door glass 5 can be pressed outside of the vehicle.

The interior seal lip 31 is provided so as to obliquely extend from the leading edge of the interior side wall 30 toward the inside of the main body of the glass run 10. As mentioned previously, both side surfaces of the leading edge of the door glass 5 are held between the interior seal lip 31 and the vehicle-exterior wind lip 21. In accordance with ascending or descending operation of the door glass 5, the interior seal lip 31 and the vehicle-exterior wind lip 21 contact the side surfaces of the door glass 5, so that the space between the door frame 2 and the door glass 5 can be sealed.

The interior seal lip 31 is formed with a sponge material as is the interior side wall 30. The interior seal lip 31 can be produced from a sponge material having low specific gravity, so that the overall weight of the glass run 10 can be greatly reduced, to contribute to weight reduction of the vehicle.

The specific gravity of the sponge material preferably ranges from 0.3 to 0.8. When the interior seal lip 31 is produced from a sponge material whose specific gravity ranges from 0.3 to 0.8, the overall weight of the glass run 10 can be greatly reduced.

As mentioned previously, a low sliding resistance material layer 38 can be produced on the surface of the interior seal lip 31. In this case, sliding resistance existing between the interior seal lip 31 and the door glass 5 can be reduced, so that smooth ascending or descending operation of the door glass 5 can be maintained.

The low sliding resistance material layer 38 can be produced by application of a material, which contains a large proportion of olefin in thermoplastic elastomer and which exhibits low sliding resistance, or a silicon resin or an urethane resin, as in the case of the vehicle-exterior wind lip 21.

The interior cover lip 32 is provided so as to extend from the leading edge of the interior side wall 30 in an upwardly-slanting direction. The interior cover lip 32 is formed so as to cover an interior flexion of the outer panel 2c of the door flame 2 and a leading edge of a garnish 70 attached to the interior side of the door frame 2. Thus, clearance among the outer panel 2c, the garnish 70, and the door glass 5 is sealed, to provide superior appearance.

The bottom wall 40 will now be described.

The bottom wall 40 is essentially formed into the shape of a plate, and a groove is formed in a continual area between the interior side wall 30 and the vehicle-exterior side wall 20 so as to facilitate generation of the flexion. A bottom wall seal lip 41 is formed at a vehicle-exterior side edge of a vehicle-exterior surface of the bottom wall 40 and contacts a bottom surface of the outer panel 2c, to seal a space between the door frame 2 and the glass run 10.

A bottom wall low sliding resistance material layer 43 is formed on that interior surface of the main body of the glass run 10 of the bottom wall 40 which has a substantially U-shaped cross section, as in the case of the vehicle-exterior wind lip 21 and the interior seal lip 31. Therefore, sliding resistance arising between the door glass 5 and the glass run of the bottom wall can be reduced. The bottom wall low sliding resistance material layer 43 can be made by flocking short fiber.

The bottom wall 40 is formed with rubber, a solid material of a thermoplastic elastomer, or a microfoaming solid material. Therefore, the bottom wall 40 exhibits high rigidity. When the door glass 5 ascends, to enter the main body of the glass run 10, anomalous deformation of the bottom wall 40, which would otherwise be caused as a result of the bottom wall being pressed or drawn by the leading edge of the door glass 5, does not arise, so that the vehicle-exterior side wall 20 and the interior side wall 30 can be securely held.

The bottom wall 40 is made of a solid material or a microfoaming solid material, specific gravity of which ranges from 0.8 to 1.2. In the case of the microfoaming solid material, specific gravity is of the order of 0.8 to 1.0. In the case of the solid material, specific gravity is of the order of 1.0 to 1.2. Therefore, an increase in weight of the bottom wall can be prevented while the rigidity of the bottom wall 40 is maintained.

Compared with the vehicle-exterior side wall 20 and the interior side wall 30, the bottom wall 40 has a smaller volume. Even when specific gravity of the bottom wall is of the order of 0.8 to 1.0, the chance of an increase in the overall weight of the glass run 10 is small.

During molding of the linear portions 11 of the glass run 10, a solid material of a thermoplastic elastomer or EPDM rubber and a sponge material are used as molding materials. A polyolefin-based elastomer, or the like, is used as the thermoplastic elastomer. In the case of the EPDM rubber, the rubber is heated and cured after being subjected to extrusion molding.

The corners 12 of the glass run 10 are also formed with an olefin-based thermoplastic elastomer or EPDM rubber. These materials are of the same type, and superior adhesion between the linear portions 11 and the corners 12 of the glass run 10 is achieved. Each of these materials is an olefin-based material, and hence there can be obtained products which exhibit superior weatherability, which can be simultaneously pulverized, and which are easy to recycle.

What is claimed is:

1. An automotive glass run attached to an inner peripheral part of a longitudinal side of a door frame of an automotive door and that guides ascending and descending a door glass, comprising:
a main body having a substantially U-shaped cross section formed with a vehicle-exterior side wall, a vehicle-interior side wall and a bottom wall,
wherein a vehicle-exterior wind lip is extended from a leading edge of the vehicle-exterior side wall in a direction that is slant toward outside of the main body for contacting the door glass, and
a vehicle-interior seal lip is extended from the vehicle-interior side wall toward an inside of the main body;
wherein the bottom wall is made of a solid material or a microfoaming solid material, and the vehicle-exterior side wall and the vehicle-interior side wall are made from a sponge material;
wherein a vehicle-exterior projection having a triangular cross section, a top of which protrudes inwardly so as to be contact the door glass is formed on a vehicle-interior surface of the vehicle-exterior side wall, and
a low sliding resistance material layer is formed on a surface of the vehicle-exterior projection; and
wherein the vehicle-exterior projection seals a vehicle-exterior side surface of an edge of the door glass, and the vehicle-interior seal lip seals a vehicle-interior side surface of the edge of the door glass.

2. The automotive glass run according to claim 1, wherein, in the triangular cross section of the vehicle-exterior projection, one edge of a bottom side of the triangular cross section is located in a vicinity of a joint between the projection and the bottom of the vehicle-exterior side wall, and another edge of the bottom side is located in a vicinity of a leading edge of the vehicle-exterior side wall.

3. The automotive glass run according to claim 1, wherein the low sliding resistance material layer on the surface of the vehicle-exterior projection is an olefin-based resin sheet.

4. The automotive glass run according to claim 1, wherein the low sliding resistance material layer is formed with an ultrahigh molecular polyethylene layer.

5. The automotive glass run according to claim 1, wherein the low sliding resistance material layer is formed on a vehicle-interior surface of the vehicle-exterior seal lip and a surface of the vehicle-interior seal lip.

6. The automotive glass run according to claim 1, wherein the vehicle-interior side wall and the vehicle-interior seal lip are formed so as to become larger and thicker than the vehicle-exterior side wall and the vehicle-exterior seal lip, respectively.

7. The automotive glass run according to claim 1, wherein specific gravity of the sponge material ranges from 0.3 to 0.8.

8. The automotive glass run according to claim 1, wherein specific gravity of the solid material or the microfoaming solid material ranges from 0.8 to 1.2.

9. The automotive glass run according to claim 1, wherein a recess is formed in a vehicle-exterior surface of the vehicle-exterior side wall, and an operation of the door frame or an operation of a door molding is fitted into the recess, thereby holding the vehicle-exterior side wall.
